(19) United States
(12) Patent Application Publication
(10) Pub. No.: US 2020/0236694 A1
(43) Pub. Date: Jul. 23, 2020

(54) TECHNIQUES FOR CONFIGURING SCHEDULING REQUEST FOR SIDELINK IN WIRELESS COMMUNICATIONS

(71) Applicant: QUALCOMM Incorporated, San Diego, CA (US)

(72) Inventors: Zhibin WU, Los Altos, CA (US); Sudhir Kumar BAGHEL, Hillsborough, NJ (US); Arjun BHARADWAJ, Cupertino, CA (US); Dan VASSILOVSKI, Del Mar, CA (US)

(21) Appl. No.: 16/746,364

(22) Filed: Jan. 17, 2020

Related U.S. Application Data
(60) Provisional application No. 62/795,325, filed on Jan. 22, 2019.

(51) Int. Cl. H04W 72/12; H04L 1/18; H04W 4/40

(52) U.S. Cl. CPC H04W 72/1263; H04W 72/1289; H04W 72/1284; H04W 92/18; H04L 1/1812; H04W 4/40; H04L 1/1887

(57) ABSTRACT

Aspects described herein relate to receiving an indication of multiple scheduling request (SR) configurations for a logical channel, transmitting a first transmission of an SR based on a first one of the multiple SR configurations, and transmitting a second transmission of the SR based on a second one of the multiple SR configurations.

### CLAIM OF PRIORITY UNDER 35 U.S.C. § 119

The present Application for Patent claims priority to Provisional Application No. 62/795,325, entitled “TECHNIQUES FOR CONFIGURING SCHEDULING REQUEST FOR SIDELINK IN WIRELESS COMMUNICATIONS” filed Jan. 22, 2019, which is assigned to the assignee hereof and hereby expressly incorporated by reference herein for all purposes.

### BACKGROUND

Aspects of the present disclosure relate generally to wireless communication systems, and more particularly, to configuring scheduling requests (SR).

Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems, and single-carrier frequency division multiple access (SC-FDMA) systems.

These multiple access technologies have been adopted in various telecommunication standards to provide a common protocol that enables different wireless devices to communicate on a municipal, national, regional, and even global level. For example, a fifth generation (5G) wireless communications technology (which can be referred to as 5G new radio (5G NR)) is envisaged to expand and support diverse usage scenarios and applications with respect to current mobile network generations. In an aspect, 5G communications technology can include: enhanced mobile broadband addressing human-centric use cases for access to multimedia content, services and data; ultra-reliable-low latency communications (URLLC) with certain specifications for latency and reliability; and massive machine type communications, which can allow a very large number of connected devices and transmission of a relatively low volume of non-delay-sensitive information.

In some wireless communication technologies, devices (e.g., user equipment) can send a scheduling request (SR) to a base station to solicit uplink resource grants from the base station. For a given logical channel between the device and base station, the device is configured with at most one physical uplink control channel (PUCCH) for SR, and the base station can transmit hybrid automatic repeat/request (HARD) feedback indicating whether data transmission over the granted resources is received from the device, where the feedback and/or a subsequent transmission from the base station may include additional resources for retransmitting the data if the data transmission is not properly received. Devices in 5G NR may also communicate with other devices over a sidelink, and may use SR to solicit sidelink grants from the base station.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method of wireless communication is provided. The method includes receiving an indication of multiple scheduling request (SR) configurations for a logical channel, transmitting a first transmission of an SR based on a first one of the multiple SR configurations to request resources for transmitting data over first resources of the logical channel, and transmitting a second transmission of the SR based on a second one of the multiple SR configurations to request resources for retransmitting data over second resources of the logical channel.

In another example, a method for wireless communications is provided. The method includes generating an indication of multiple SR configurations for a logical channel, and transmitting, to a device, the indication of the multiple SR configurations for transmitting SR for the logical channel.

In another example, an apparatus for wireless communication is provided that includes a transceiver, a memory configured to store instructions, and one or more processors communicatively coupled with the transceiver and the memory. The one or more processors are configured to receive an indication of multiple SR configurations for a logical channel, transmit a first transmission of an SR based on a first one of the multiple SR configurations to request resources for transmitting data over first resources of the logical channel, and transmit a second transmission of the SR based on a second one of the multiple SR configurations to request resources for retransmitting data over second resources of the logical channel.

In another example, an apparatus for wireless communication is provided that includes a transceiver, a memory configured to store instructions, and one or more processors communicatively coupled with the transceiver and the memory. The one or more processors are configured to generate an indication of multiple SR configurations for a logical channel, and transmit, to a device, the indication of the multiple SR configurations for transmitting SR for the logical channel.

In another example, an apparatus for wireless communications is provided that includes means for receiving an indication of multiple SR configurations for a logical channel, means for transmitting a first transmission of an SR based on a first one of the multiple SR configurations to request resources for transmitting data over first resources of the logical channel, and means for transmitting a second transmission of the SR based on a second one of the multiple SR configurations to request resources for retransmitting data over second resources of the logical channel.

In yet another example, an apparatus for wireless communications is provided that includes means for generating an indication of multiple SR configurations for a logical channel, and means for transmitting, to a device, the indication of the multiple SR configurations for transmitting SR for the logical channel.

In another example, a computer-readable medium including code executable by one or more processors for wireless communications is provided. The code includes code for receiving an indication of multiple SR configurations for a logical channel, code for transmitting a first transmission of an SR based on a first one of the multiple SR configurations to request resources for transmitting data over first resources of the logical channel, and code for transmitting a second transmission of the SR based on a second one of the multiple SR configurations to request resources for retransmitting data over second resources of the logical channel.

In another example, a computer-readable medium including code executable by one or more processors for wireless communications is provided. The code includes code for generating an indication of multiple SR configurations for a logical channel, and code for transmitting, to a device, the indication of the multiple SR configurations for transmitting SR for the logical channel.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates an example of a wireless communication system, in accordance with various aspects of the present disclosure;

FIG. 2 is a block diagram illustrating an example of a UE, in accordance with various aspects of the present disclosure;

FIG. 3 is a block diagram illustrating an example of a base station, in accordance with various aspects of the present disclosure;

FIG. 4 is a flow chart illustrating an example of a method for using multiple scheduling request (SR) configurations, in accordance with various aspects of the present disclosure;

FIG. 5 is a flow chart illustrating an example of a generating multiple SR configurations, in accordance with various aspects of the present disclosure; and

FIG. 6 is a block diagram illustrating an example of a MIMO communication system including a base station and a UE, in accordance with various aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

The concepts are generally described herein with respect to device-to-device (D2D) communication technologies. For example, D2D communication technologies can include vehicle-to-vehicle (V2V) communications, vehicle-to-infrastructure (V2I) communications (e.g., from a vehicle-based communication device to road infrastructure nodes), vehicle-to-network (V2N) communications (e.g., from a vehicle-based communication device to one or more network nodes, such as a base station), a combination thereof and/or with other devices, which can be collectively referred to as vehicle-to-anything (V2X) communications. In V2X communications, vehicle-based communication devices can communicate with one another and/or with infrastructure devices over a sidelink channel. Continued support and implementation of V2X communications is provided in fifth generation (5G) new radio (NR) communication technologies, as well as long term evolution (LTE). Though aspects are generally described herein in terms of D2D/V2X communications, the concepts and techniques can be similarly applied more generally to substantially any type of wireless communications.

The described features generally relate to configuring scheduling request (SR) for sidelink channel communications between devices in a wireless network. A device can use SR to solicit sidelink grants from a base station for a sidelink channel, where the sidelink channel is used for D2D (e.g., or V2X) communications. Generally, SR can be a layer 1 (L1, e.g., physical (PHY) layer) messaging on an interface between a user equipment (UE) and a base station (e.g., gNB). This interface is further referred to herein as “Uu” or “Uu interface” which can be defined in wireless communication technologies such as NR, LTE, etc. In LTE, for uplink (e.g., and not sidelink) communications, each device can typically be configured (by the network) with zero, one, or more SR configurations, but at most only one physical uplink control channel (PUCCH) resource for SR per bandwidth part (BWP). Each SR configuration for the device may correspond to functioning of one or more logical channels, and radio resource control (RRC) configuration can be used to configure whether a logical channel is to use the SR configuration or not.

In the Uu interface for communications between the device (e.g., UE) and base station (e.g., eNB/gNB) in LTE, NR, or similar technologies (e.g., as opposed to D2D communications), retransmission resource grants (e.g., hybrid automatic repeat/request (HARQ) retransmissions) are allocated by the base station, as described, because the base station is the entity receiving and providing acknowledgement (ACK)/non-acknowledgement (NACK) feedback for the prior transmission. For some D2D operations, for example, such as Mode 1 V2X device operation, devices (e.g., UEs) are assisted by the base stations in receiving resources to use for sideline communications with other devices. For such operations, devices can send SR to the base station in the physical layer to solicit sidelink channel grants. In this example for sidelink, however, whether the prior packet transmitted over granted sidelink resources is to be retransmitted or not is decided by a device and not the base station scheduling the resources, as the base station neither receives the prior transmission nor provides ACK/NACK feedback for the transmission in the sidelink channel. Thus, where NACK feedback is received (or no feedback is received) for transmitted sidelink communications, a device can send another SR for additional resources to retransmit the sidelink communications; however, latency associated with sending another SR in configured SR resources may be prohibitive for retransmission (e.g., HARQ) purposes.

Accordingly, aspects described herein relate to providing multiple SR configurations for each sidelink logical channel, such that more than one PUCCH resource can be configured for SR (e.g., one SR configuration for initial/original transmission and one or more additional SR configurations for retransmission). In this example, each SR configuration can indicate whether it is for original SR transmission or SR retransmission due to receiving sidelink NACK (or not timely receiving an ACK) for a previous SR transmission/retransmission. In an example, the number of SR configurations provided may be based on the number of times retransmission is allowed in a configured HARQ scheme. In any case, the device can be configured, by the base station, with multiple configurations (e.g., opportunities) for transmitting SR for a sidelink channel as may be needed (e.g., based on feedback from one or more devices receiving corresponding sidelink channel communications). In this example, the device can send a SR to request resources for retransmission based on the specific SR configuration for retransmission without having to wait for a next opportunity to transmit SR based on the conventional single SR configuration.

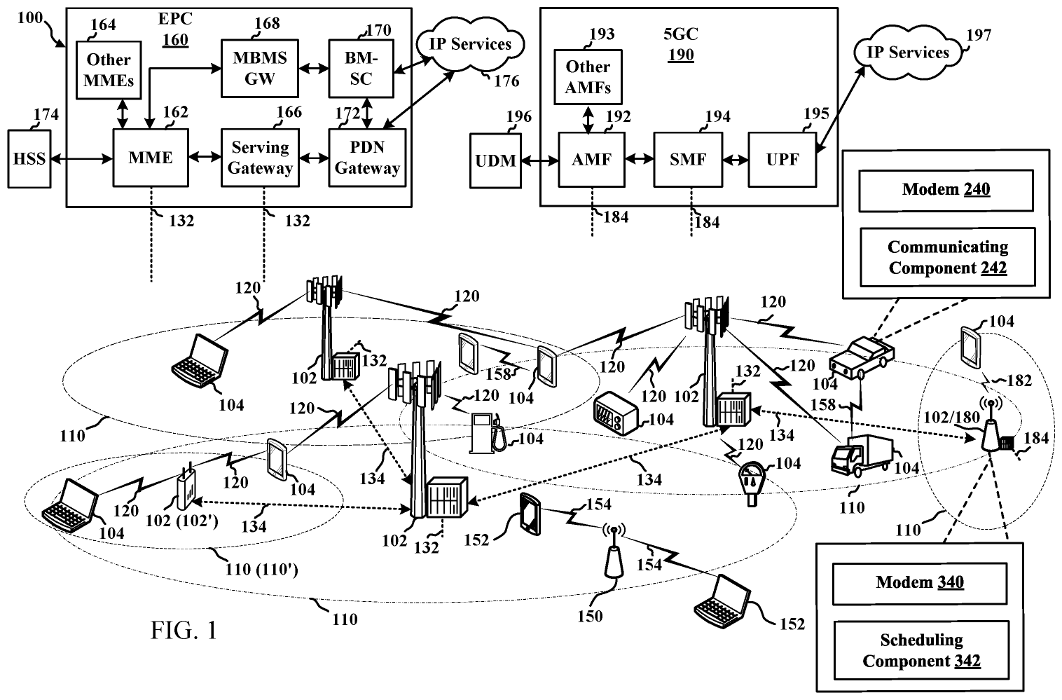

The described features will be presented in more detail below with reference to FIGS. 1-6.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component can be localized on one computer and/or distributed between two or more computers. In addition, these components can execute from various computer readable media having various data structures stored thereon. The components can communicate by way of local and/or remote processes such as in accordance with a signal having one or more data packets, such as data from one component interacting with another component in a local system, distributed system, and/or across a network such as the Internet with other systems by way of the signal.

Techniques described herein may be used for various wireless communication systems such as CDMA, TDMA, FDMA, OFDMA, SC-FDMA, and other systems. The terms “system” and “network” may often be used interchangeably. A CDMA system may implement a radio technology such as CDMA2000, Universal Terrestrial Radio Access (UTRA), etc. CDMA2000 covers IS-2000, IS-95, and IS-856 standards. IS-2000 Releases 0 and A are commonly referred to as CDMA2000 1X, 1X, etc. IS-856 (TIA-856) is commonly referred to as CDMA2000 1xEV-DO, High Rate Packet Data (HRPD), etc. UTRA includes Wideband CDMA (WCDMA) and other variants of CDMA. A TDMA system may implement a radio technology such as Global System for Mobile Communications (GSM). An OFDMA system may implement a radio technology such as Ultra Mobile Broadband (UMB), Evolved UTRA (E-UTRA), IEEE 802.11 (Wi-Fi), IEEE 802.16 (WiMAX), IEEE 802.20, Flash-OFDM™, etc. UTRA and E-UTRA are part of Universal Mobile Telecommunication System (UMTS). 3GPP Long Term Evolution (LTE) and LTE-Advanced (LTE-A) are new releases of UMTS that useE-UTRA. UTRA, E-UTRA, UMTS, LTE, LTE-A, and GSM are described in documents from an organization named “3rd Generation Partnership Project” (3GPP). CDMA2000 and UMB are described in documents from an organization named “3rd Generation Partnership Project 2” (3GPP2). The techniques described herein may be used for the systems and radio technologies mentioned above as well as other systems and radio technologies, including cellular (e.g., LTE) communications over a shared radio frequency spectrum band. The description below, however, describes an LTE/LTE-A system for purposes of example, and LTE terminology is used in much of the description below, although the techniques are applicable beyond LTE/LTE-A applications (e.g., to fifth generation (5G) new radio (NR) networks or other next generation communication systems).

The following description provides examples, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in other examples.

Various aspects or features will be presented in terms of systems that can include a number of devices, components, modules, and the like. It is to be understood and appreciated that the various systems can include additional devices, components, modules, etc. and/or may not include all of the devices, components, modules etc. discussed in connection with the figures. A combination of these approaches can also be used.

FIG. 1 is a diagram illustrating an example of a wireless communications system and an access network 100. The wireless communications system (also referred to as a wireless wide area network (WWAN)) can include base stations 102, UEs 104, an Evolved Packet Core (EPC) 160, and/or a 5G Core (5GC) 190. The base stations 102 may include macro cells (high power cellular base station) and/or small cells (low power cellular base station). The macro cells can include base stations. The small cells can include femtocells, picocells, and microcells. In an example, the base stations 102 may also include gNBs 180, as described further herein. In one example, some nodes of the wireless communication system may have a modem 240 and communicating component 242 for receiving multiple SR configurations, and some nodes may have a modem 340 and scheduling component 342 for configuring multiple SR configurations, as described herein. Though a UE 104 is shown as having the modem 240 and communicating component 242 and a base station 102/gNB 180 is shown as having the modem 340 and scheduling component 342, this is one illustrative example, and substantially any node or type of node may include a modem 240 and communicating component 242 and/or a modem 340 and scheduling component 342 for providing corresponding functionalities described herein.

The base stations 102 configured for 4G LTE (which can collectively be referred to as Evolved Universal Mobile Telecommunications System (UMTS) Terrestrial Radio Access Network (E-UTRAN)) may interface with the EPC 160 through backhaul links 132 (e.g., using an S1 interface). The base stations 102 configured for 5G NR (which can collectively be referred to as Next Generation RAN (NG-RAN)) may interface with 5GC 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or 5GC 190) with each other over backhaul links 134 (e.g., using an X2 interface). The backhaul links 134 may be wired or wireless.

The base stations 102 may wirelessly communicate with one or more UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be referred to as a heterogeneous network. A heterogeneous network may also include Home Evolved Node Bs (eNBs) (HeNBs), which may provide service to a restricted group, which can be referred to as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (e.g., for x component carriers) used for transmission in the DL and/or the UL direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

In another example, certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or other type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 182 with the UE 104 to compensate for the extremely high path loss and short range. A base station 102 referred to herein can include a gNB 180.

The EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The 5GC 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 can be a control node that processes the signaling between the UEs 104 and the 5GC 190. Generally, the AMF 192 can provide QoS flow and session management. User Internet protocol (IP) packets (e.g., from one or more UEs 104) can be transferred through the UPF 195. The UPF 195 can provide UE IP address allocation for one or more UEs, as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or 5GC 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). IoT UEs may include machine type communication (MTC)/enhanced MTC (eMTC, also referred to as category (CAT)-M, Cat M1) UEs, NB-IoT (also referred to as CAT NB1) UEs, as well as other types of UEs. In the present disclosure, eMTC and NB-IoT may refer to future technologies that may evolve from or may be based on these technologies. For example, eMTC may include FeMTC (further eMTC), eFeMTC (enhanced further eMTC), mMTC (massive MTC), etc., and NB-IoT may include eNB-IoT (enhanced NB-IoT), FeNB-IoT (further enhanced NB-IoT), etc. The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

In an example, referring to the D2D communications described above, where the devices are vehicles or otherwise vehicle-based, the D2D communications between the devices (e.g., over a sidelink channel of communication link 158) can be referred to as V2V communications, which are defined for 3GPP LTE and are being defined for 5G NR. When the vehicles or vehicle-based devices communicate with other infrastructure nodes for the vehicle-based communications (e.g., over the sidelink), this can be referred to as V2I communications. When the vehicles or vehicle-based devices communicate with a base station 102 or other network node (e.g., over a communication link 120), this can be referred to as V2N communications. The collection of V2V, V2I, V2N, and/or vehicle-to-anything else can be referred to as V2X communications. In an example, LTE can support V2X communications (referred to as “LTE-V2X”) for safety messages communicated between vehicles and/or from vehicles to infrastructure. 5G NR can also support V2X (referred to as “NR-V2X”) for communications related to autonomous driving. For example, sidelink V2X communications may occur in a dedicated portion of spectrum such as the 5.9 GHz dedicated short range communications (DSRC) bandwidth reserved for vehicle communications.

In aspects described herein, UE 104 can include a modem 240 for communicating with other UEs and/or base stations in a wireless network. UE 104 can include a communicating component 242 for transmitting V2X (or more generally D2D) communications to one or more other UEs 104 over a sidelink channel. In one example, e.g., in Mode 1 V2X operations, a base station 102 can assist in the communications by scheduling resources for the UEs 104 to use in communicating over the sidelink channel. In addition, in this example, the base station 102 can provide the UE(s) 104 with SR configurations for transmitting SR to the base station 102 to solicit sidelink channel grants from the base station 102. For example, the base station 102 can also include a modem 340 for communicating with UEs, and a scheduling component 342 for configuring the UEs (or assisting in configuring UEs) with resources for communicating in a wireless network. In an example, scheduling component 342 may configure one or more UEs 104 with multiple SR configurations per channel. For example, scheduling component 342 can configure the one or more UEs 104 each with multiple SR configurations for soliciting sidelink channel grants, where the multiple SR configurations may include an SR configuration for transmitting an original transmission of data and one or more additional SR configurations for retransmitting the data.

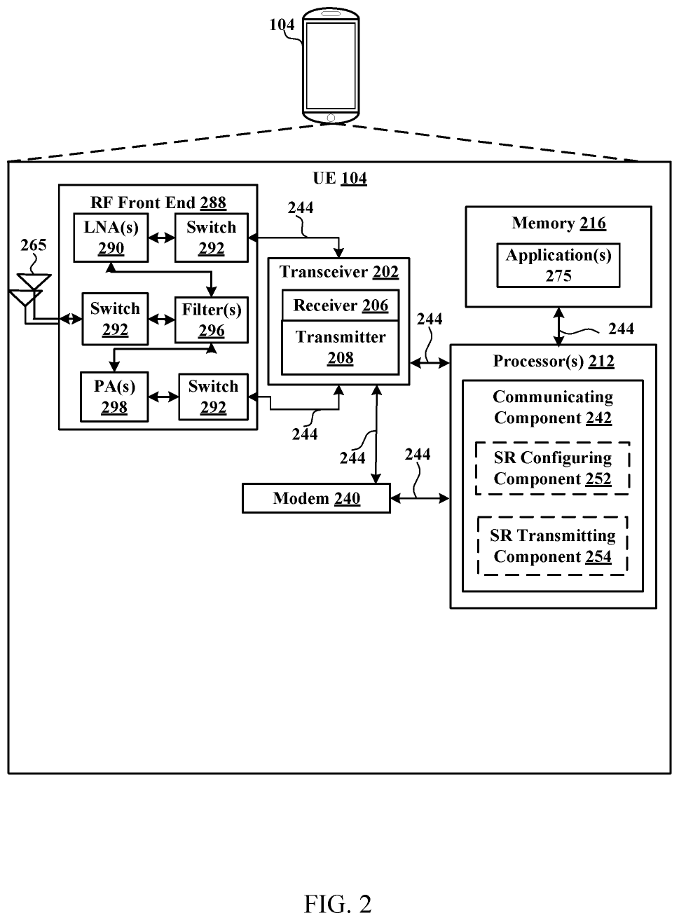

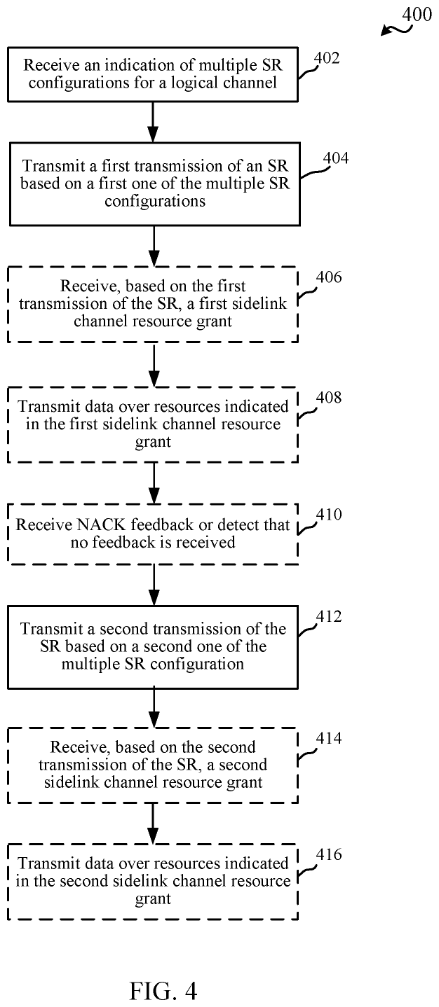

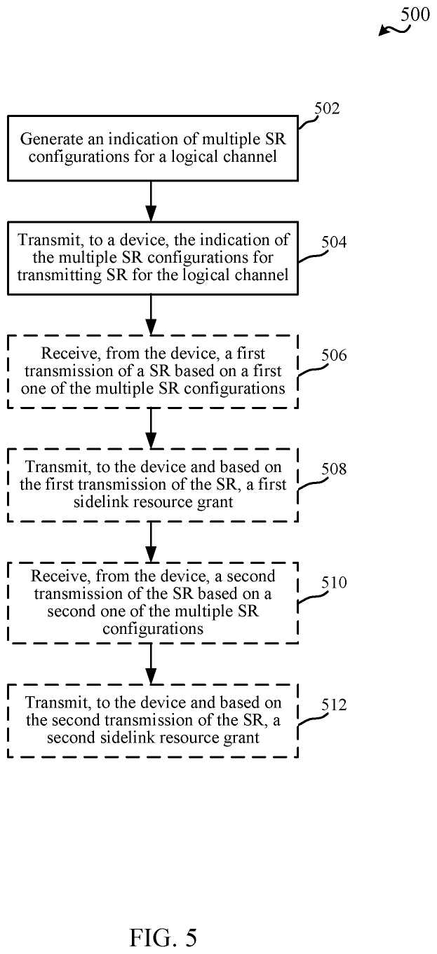

Turning now to FIGS. 2-6, aspects are depicted with reference to one or more components and one or more methods that may perform the actions or operations described herein, where aspects in dashed line may be optional. Although the operations described below in FIGS. 4-5 are presented in a particular order and/or as being performed by an example component, it should be understood that the ordering of the actions and the components performing the actions may be varied, depending on the implementation. Moreover, it should be understood that the following actions, functions, and/or described components may be performed by a specially programmed processor, a processor executing specially programmed software or computer-readable media, or by any other combination of a hardware component and/or a software component capable of performing the described actions or functions.

Referring to FIG. 2, one example of an implementation of UE 104 may include a variety of components, some of which have already been described above and are described further herein, including components such as one or more processors 212 and memory 216 and transceiver 202 in communication via one or more buses 244, which may operate in conjunction with modem 240 and/or communicating component 242 to configure multiple SR transmissions.

In an aspect, the one or more processors 212 can include a modem 240 and/or can be part of the modem 240 that uses one or more modem processors. Thus, the various functions related to communicating component 242 may be included in modem 240 and/or processors 212 and, in an aspect, can be executed by a single processor, while in other aspects, different ones of the functions may be executed by a combination of two or more different processors. For example, in an aspect, the one or more processors 212 may include any one or any combination of a modem processor, or a baseband processor, or a digital signal processor, or a transmit processor, or a receiver processor, or a transceiver processor associated with transceiver 202. In other aspects, some of the features of the one or more processors 212 and/or modem 240 associated with communicating component 242 may be performed by transceiver 202.

Also, memory 216 may be configured to store data used herein and/or local versions of applications 275 or communicating component 242 and/or one or more of its subcomponents being executed by at least one processor 212. Memory 216 can include any type of computer-readable medium usable by a computer or at least one processor 212, such as random access memory (RAM), read only memory (ROM), tapes, magnetic discs, optical discs, volatile memory, non-volatile memory, and any combination thereof. In an aspect, for example, memory 216 may be a non-transitory computer-readable storage medium that stores one or more computer-executable codes defining communicating component 242 and/or one or more of its subcomponents, and/or data associated therewith, when UE 104 is operating at least one processor 212 to execute communicating component 242 and/or one or more of its subcomponents.

Transceiver 202 may include at least one receiver 206 and at least one transmitter 208. Receiver 206 may include hardware, firmware, and/or software code executable by a processor for receiving data, the code comprising instructions and being stored in a memory (e.g., computer-readable medium). Receiver 206 may be, for example, a radio frequency (RF) receiver. In an aspect, receiver 206 may receive signals transmitted by at least one base station 102. Additionally, receiver 206 may process such received signals, and also may obtain measurements of the signals, such as, but not limited to, Ec/Io, signal-to-noise ratio (SNR), reference signal received power (RSRP), received signal strength indicator (RSSI), etc. Transmitter 208 may include hardware, firmware, and/or software code executable by a processor for transmitting data, the code comprising instructions and being stored in a memory (e.g., computer-readable medium). A suitable example of transmitter 208 may including, but is not limited to, an RF transmitter.

Moreover, in an aspect, UE 104 may include RF front end 288, which may operate in communication with one or more antennas 265 and transceiver 202 for receiving and transmitting radio transmissions, for example, wireless communications transmitted by at least one base station 102 or wireless transmissions transmitted by UE 104. RF front end 288 may be connected to one or more antennas 265 and can include one or more low-noise amplifiers (LNAs) 290, one or more switches 292, one or more power amplifiers (PAs) 298, and one or more filters 296 for transmitting and receiving RF signals.

In an aspect, LNA 290 can amplify a received signal at a desired output level. In an aspect, each LNA 290 may have a specified minimum and maximum gain values. In an aspect, RF front end 288 may use one or more switches 292 to select a particular LNA 290 and its specified gain value based on a desired gain value for a particular application.

Further, for example, one or more PA(s) 298 may be used by RF front end 288 to amplify a signal for an RF output at a desired output power level. In an aspect, each PA 298 may have specified minimum and maximum gain values. In an aspect, RF front end 288 may use one or more switches 292 to select a particular PA 298 and its specified gain value based on a desired gain value for a particular application.

Also, for example, one or more filters 296 can be used by RF front end 288 to filter a received signal to obtain an input RF signal. Similarly, in an aspect, for example, a respective filter 296 can be used to filter an output from a respective PA 298 to produce an output signal for transmission. In an aspect, each filter 296 can be connected to a specific LNA 290 and/or PA 298. In an aspect, RF front end 288 can use one or more switches 292 to select a transmit or receive path using a specified filter 296, LNA 290, and/or PA 298, based on a configuration as specified by transceiver 202 and/or processor 212.

As such, transceiver 202 may be configured to transmit and receive wireless signals through one or more antennas 265 via RF front end 288. In an aspect, transceiver may be tuned to operate at specified frequencies such that UE 104 can communicate with, for example, one or more base stations 102 or one or more cells associated with one or more base stations 102. In an aspect, for example, modem 240 can configure transceiver 202 to operate at a specified frequency and power level based on the UE configuration of the UE 104 and the communication protocol used by modem 240.

In an aspect, modem 240 can be a multiband-multimode modem, which can process digital data and communicate with transceiver 202 such that the digital data is sent and received using transceiver 202. In an aspect, modem 240 can be multiband and be configured to support multiple frequency bands for a specific communications protocol. In an aspect, modem 240 can be multimode and be configured to support multiple operating networks and communications protocols. In an aspect, modem 240 can control one or more components of UE 104 (e.g., RF front end 288, transceiver 202) to enable transmission and/or reception of signals from the network based on a specified modem configuration. In an aspect, the modem configuration can be based on the mode of the modem and the frequency band in use. In another aspect, the modem configuration can be based on UE configuration information associated with UE 104 as provided by the network during cell selection and/or cell reselection.

In an aspect, communicating component 242 can optionally include a SR configuring component 252 for configuring multiple SR configurations for a logical channel, and/or an SR transmitting component 254 for transmitting multiple SRs for the logical channel based on the SR configurations.

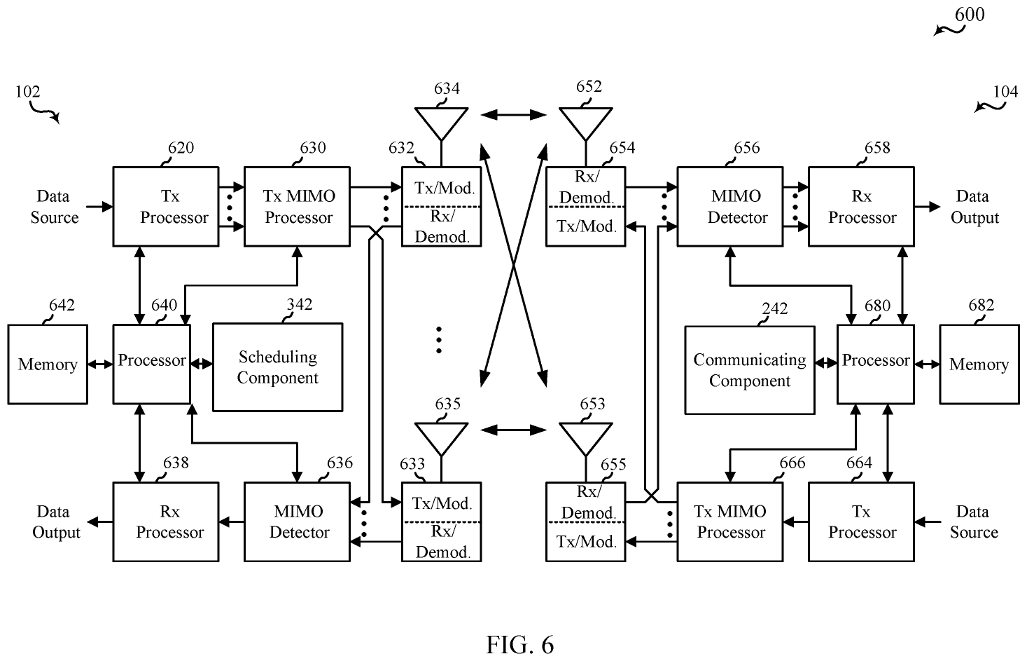

In an aspect, the processor(s) 212 may correspond to one or more of the processors described in connection with the UE in FIG. 6. Similarly, the memory 216 may correspond to the memory described in connection with the UE in FIG. 6.

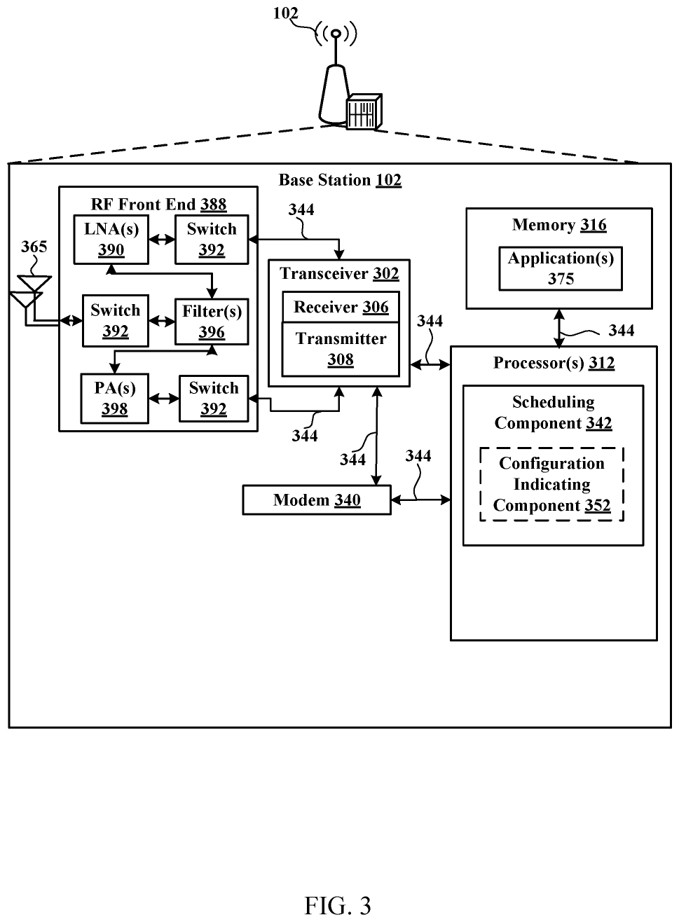

Referring to FIG. 3, one example of an implementation of base station 102 (e.g., a base station 102 and/or gNB 180, as described above) may include a variety of components, some of which have already been described above, but including components such as one or more processors 312 and memory 316 and transceiver 302 in communication via one or more buses 344, which may operate in conjunction with modem 340 and scheduling component 342 for configuring a UE 104 with multiple SR configurations.

The transceiver 302, receiver 306, transmitter 308, one or more processors 312, memory 316, applications 375, buses 344, RF front end 388, LNAs 390, switches 392, filters 396, PAs 398, and one or more antennas 365 may be the same as or similar to the corresponding components of UE 104, as described above, but configured or otherwise programmed for base station operations as opposed to UE operations.

In an aspect, scheduling component 342 can optionally include a configuration indicating component 352 for generating and/or transmitting multiple SR configurations (or otherwise an indication of multiple SR configurations) configured for a UE 104 to transmit SR to solicit grants for a sidelink.

In an aspect, the processor(s) 312 may correspond to one or more of the processors described in connection with the base station in FIG. 6. Similarly, the memory 316 may correspond to the memory described in connection with the base station in FIG. 6.

FIG. 4 illustrates a flow chart of an example of a method 400 for receiving and/or utilizing multiple SR configurations for a logical channel. In an example, a UE 104 can perform the functions described in method 400 using one or more of the components described in FIGS. 1-2.

In method 400, at Block 402, an indication of multiple SR configurations can be received for a logical channel. In an aspect, SR configuring component 252, e.g., in conjunction with processor(s) 212, memory 216, transceiver 202, communicating component 242, etc., can receive the indication of the multiple SR configurations for the logical channel. For example, a base station 102 can configure the UE 104 with the multiple SR configurations for the logical channel. In an example, the base station 102 can transmit the indication of the multiple SR configurations to the UE 104. In an example, the base station 102 can transmit the indication using radio resource control (RRC) signaling, dedicated control signaling, etc., and may transmit the indication before the UE 104 transmits SRs over the logical channel. In one example, base station 102 may configure multiple possible SR configurations in RRC signaling for the UE 104 and then may configure a subset of the multiple possible SR configurations for a given logical channel using dedicated control signaling for the logical channel. In this example, SR configuring component 252 can receive the dedicated control signaling as the indication of the subset of the multiple possible SR configurations (e.g., via index or other identifier). In other examples, SR configuring component 252 can receive RRC signaling (e.g., as transmitted by a base station 102) to indicate whether and/or which SR configurations to use in transmitting SR to solicit sidelink channel grants.

In any case, the UE 104 is configured with multiple SR configurations in this regard to allow for transmitting multiple SRs for the logical channel. The multiple SR configurations can allow, for example, transmitting a SR for an original transmission and transmitting one or more additional SRs for one or more retransmissions of the original transmission (e.g., without having to wait for another SR transmissions opportunity based on a single SR configuration). For example, where data transmissions over the logical channel (over resources granted based on a first SR) are not received (e.g., as indicated by NACK feedback or detecting no feedback), another SR configuration can be used to transmit a SR for retransmission resources. In addition, for example, SR configuring component 252 can receive the indication of the multiple SR configurations as multiple PUCCH resources for SR configured for each of multiple bandwidth parts (BWPs). For example, the BWPs can correspond to portions of bandwidth assignable in a wireless communication technology, such as portions of frequency in a system bandwidth, which may correspond to a channel for wireless communications with a base station, other devices, etc. In an example, the BWPs can each be associated with a bandwidth and a center frequency, which can vary among BWPs in the set.

Configuring more than one PUCCH resource for SR per BWP can allow the UE 104 to transmit SR over the additional PUCCH resources for additional retransmission resources where sidelink transmissions over initial resources that are granted based on an initial SR transmission (or one or more subsequent SR retransmissions) is/are not successfully received, as described herein. In one example, the logical channel may correspond to a sidelink channel between UEs 104 (e.g., V2X sidelink channel) where feedback for the channel may not be received by the base station 102 that configures or otherwise indicates the SR configurations and the associated sidelink channel resources. In this regard, where the UE 104 transmits the SR to solicit grants for the sidelink channel, and transmits data over granted sidelink channel resources, if NACK is received (e.g., from another UE 104) or otherwise detected as not received over the sidelink channel, the UE 104 can retransmit the SR to the base station (e.g., over a separate control channel, such as PUCCH) using another SR configuration, as described below.

In addition, SR configuring component 252 can receive the indication of the multiple SR configurations with an indication, for each SR configuration, of whether the SR configuration is for a resource request for an initial SR transmission or for a resource request for SR retransmission. Moreover, for example, SR configuring component 252 can receive the indication of the multiple SR configurations where an amount of the SR configurations (e.g., an integer value of a count or number of SR configurations) is set based on a number of retransmissions allowed for a configured HARQ scheme (e.g., set as equal to the number of retransmissions configured for the HARQ scheme, a number of retransmissions more or less than a number configured for the HARQ scheme, a fraction of the number of retransmissions configured for the HARQ scheme, etc.). In one example, the number of retransmissions can be configured to the UE 104 using RRC signaling from the base station 102.

In method 400, at Block 404, a first transmission of an SR can be transmitted based on a first one of the multiple SR configurations. In an aspect, SR transmitting component 254, e.g., in conjunction with processor(s) 212, memory 216, transceiver 202, communicating component 242, etc., can transmit the first transmission of the SR based on the first one of the multiple SR configurations. For example, each SR configuration can indicate resources over which the UE 104 can transmit a SR to solicit a grant of resources for logical channel. The UE 104 can transmit the first transmission of the SR as an initial transmission of SR over the resources to request logical channel resources, which may include a request for sidelink channel resources in D2D communications. In one example, SR transmitting component 254 may transmit the SR based on determining that the first one of the multiple SR configurations is indicated as being for resources for an initial transmission of SR.

As described, the SR configuration can indicate resources over which to transmit SR, such as a channel resource index (e.g., an indication of one or more resources blocks in frequency over one or more symbols in time). In this regard, for example, SR transmitting component 254 can also determine the resources over which to transmit the SR, where determining the resources can be based on one or more parameters specified in the SR configuration. In addition, SR transmitting component 254 can transmit the SR over a channel with the base station 102 (e.g., over a Uu interface), such as PUCCH, as control data over physical uplink shared channel (PUSCH), and/or the like. In addition, in one example, SR transmitting component 254 may determine the SR configuration to use in transmitting the first transmission of the SR based at least in part on a BWP over which the resources are requested (e.g., based on determining which SR(s) is/are configured for the BWP).

In method 400, optionally at Block 406, a first sidelink channel resource grant can be received based on the first transmission of the SR. In an aspect, communicating component 242, e.g., in conjunction with processor(s) 212, memory 216, transceiver 202, communicating component 242, etc., can receive, based on the first transmission of the SR (e.g., over resources indicated in one of the SR configurations), a first sidelink channel resource grant (e.g., from the base station 102). For example, the sidelink resource grant may indicate a set of frequency and/or time resources over which the UE 104 can transmit sidelink communications to another UE (e.g., in D2D or V2X communications). In an example, the first sidelink channel resource grant can be received from the base station 102 over a physical downlink control channel (PDCCH), physical downlink shared channel (PDSCH), etc. In addition, for example, the first sideline channel resource grant may indicate PSSCH resources, PSCCH resources, etc. over which the UE 104 can communicate with one or more other UEs in sidelink communications (e.g., over a sidelink interface different from the Uu interface with the base station 102).

In method 400, optionally at Block 408, data can be transmitted over resources indicated in the first sidelink channel resource grant. In an aspect, communicating component 242, e.g., in conjunction with processor(s) 212, memory 216, transceiver 202, communicating component 242, etc., can transmit data over resources indicated in the first sidelink channel resource grant. For examine, communicating component 242 can transmit sidelink communications to another UE 104 over the resources that were granted by the base station 102. This may include transmitting over a PSSCH, PSCCH, etc. to one or more other UEs, as described.

In method 400, optionally at Block 410, NACK feedback can be received or it can be detected that no feedback is received. In an aspect, SR transmitting component 254, e.g., in conjunction with processor(s) 212, memory 216, transceiver 202, communicating component 242, etc., can receive NACK feedback or detect that no feedback is received (e.g., for the data transmitted at Block 408). For example, the NACK can correspond to HARQ feedback, and may indicate that the data transmitted over the sidelink resources granted based on the SR transmission (e.g., the first transmission of the SR at Block 404) is not received or is otherwise not properly decoded by the other UE. For example, the NACK may be received over sidelink channel resources, and not from the base station 102. In another example, however, SR transmitting component 254 may detect that feedback is not received for the data transmission after a period of time, which may similarly be considered as an indication that the data transmitted over the sidelink resources is not received by the other UE. In this example, SR transmitting component 254 can utilize a timer configured for HARQ communication to determine when the period of time lapses without receiving HARQ feedback from the other UE. In either example, SR transmitting component 254 can determine that the data transmitted over the sidelink resources is not acknowledged by the other UE.

In method 400, at Block 412, a second transmission of the SR can be transmitted, over the logical channel, based on a second one of the multiple SR configurations. In an aspect, SR transmitting component 254, e.g., in conjunction with processor(s) 212, memory 216, transceiver 202, communicating component 242, etc., can transmit, over the logical channel, the second transmission of the SR based on the second one of the multiple SR configurations. For example, SR transmitting component 254 can determine resources of another one of the multiple SR configurations for transmitting the SR, which can have different configuration parameters (e.g., different resources, etc.) than the first one of the multiple SR configurations used to transmit the first transmission of the SR (e.g., at Block 404). In this regard, configuring the multiple SR configurations allows the UE 104 to transmit an SR for resources for an original transmission of data and transmit an SR for separate resources for retransmission of the data (e.g., without having the wait for the next SR used to request the resources for the original transmission). As described, for example, SR transmitting component 254 can transmit the SR using the second one of the multiple SR configurations to solicit grants for retransmission of sidelink channel communications where data transmitted based on the previous SR resulted in NACK feedback or no feedback. In one example, SR transmitting component 254 may transmit the SR based on determining that the second one of the multiple SR configurations is indicated as being for resources for retransmitting sidelink communications. Moreover, the SRs transmitted at Block 404 and Block 412 can be similar signals used to request scheduling over the associated resources.

In addition, in one example, the first transmission of the SR at Block 404 may be a request for resources for retransmission of a sidelink communication, and the second transmission at Block 412 can be a subsequent request for resources for retransmission of the sidelink communication where NACK or no feedback is received for the sidelink communication (e.g., as transmitted at Block 408). In yet another example, in transmitting the second transmission of the SR, SR transmitting component 254 may determine the resources based on how many transmissions/retransmissions of the sidelink communication have occurred before the second transmission (e.g., n transmissions), and may determine the SR configuration as the n+1 RS configuration received from the base station 102. Moreover, in an example, SR transmitting component 254 may transmit the second transmission of the SR based on determining that the number of SR configurations received from the base station 102 have not all been used (e.g., that there is at least one remaining and unused SR configuration), which may be based on determining the number of SR configurations received at Block 402 and the number of SR transmissions sent for the SR for transmitting/retransmitting the same sidelink communication. In addition, in one example, SR transmitting component 254 may determine the SR configuring to use to transmit the second transmission of the SR based at least in part on a BWP over which the resources are requested (e.g., based on determining which SR(s) is/are configured for the BWP).

In method 400, optionally at Block 414, a second sidelink channel resource grant can be received based on the second transmission of the SR. In an aspect, communicating component 242, e.g., in conjunction with processor(s) 212, memory 216, transceiver 202, etc., can receive, based on the second transmission of the SR (e.g., over resources indicated in the SR configurations), a second sidelink channel resource grant (e.g., from the base station 102). For example, the second sidelink resource grant may indicate a set of frequency and/or time resources over which the UE 104 can retransmit the sidelink communications (e.g., at transmitted at Block 408) to another UE (e.g., in D2D or V2X communications) over the sidelink channel. In an example, the second sidelink channel resource grant can be received from the base station 102 over a PDCCH, PDSCH, etc., and/or may indicate PSSCH resources, PSCCH resources, etc., as described.

In method 400, optionally at Block 416, data can be transmitted over resources indicated in the second sidelink channel resource grant. In an aspect, communicating component 242, e.g., in conjunction with processor(s) 212, memory 216, transceiver 202, etc., can transmit data over resources indicated in the second sidelink channel resource grant. For examine, communicating component 242 can retransmit the data as a retransmission of the associated sidelink communication (e.g., as transmitted at Block 408) to the UE 104 again (and/or to one or more other UEs). Communicating component 242 can retransmit the sidelink communication over the sidelink resources that were granted by the base station 102 for retransmission based on transmitting the second transmission of the SR, as described above. In addition, in an example, the UE 104 may receive ACK or NACK (or no) feedback in response to the retransmission of the sidelink communication, and may accordingly transmit another SR where NACK (or no) feedback is received and/or where a maximum number of SR configurations have not been already utilized to request sidelink channel resources for additional retransmission of the sidelink communication, as described.

FIG. 5 illustrates a flow chart of an example of a method 500 for generating and transmitting an indication of multiple SR configurations. In an example, a base station 102 (e.g., which may include a gNB 180) can perform the functions described in method 500 using one or more of the components described in FIGS. 1 and 3.

In method 500, at Block 502, an indication of multiple SR configurations for a logical channel can be generated. In an aspect, configuration indicating component 352, e.g., in conjunction with processor(s) 312, memory 316, transceiver 302, scheduling component 342, etc., can generate an indication of multiple SR configurations for a logical channel. As described, for example, configuration indicating component 352 can generate the indication as information regarding the SR configurations (e.g., parameters for transmitting SR, such as an indication of resources) and/or can configure the indication in a multiple step process. For example, configuration indicating component 352 can transmit information for multiple SR configurations (e.g., in RRC signaling), and then can indicate, for a given logical channel, corresponding BWP, etc., an indication of a subset of the multiple SR configurations to use for the logical channel (where the subset can include multiple SR configurations—one for an initial transmission, and one or more for one or more retransmission(s), etc.).

In addition, for example, configuration indicating component 352 can generate the SR configurations to indicate whether a given SR configuration is for transmitting a SR for an initial transmission or transmitting a SR for a retransmission. Moreover, configuration indicating component 352 can generate the indication to indicate a number (e.g., amount) of SR configurations, which may be based on a number of transmission/retransmissions configured for a HARQ scheme. Moreover, as described, the logical channel may relate to a sidelink channel (e.g., PSSCH, PSCCH, or other channel in D2D/V2X communications) where feedback for the sidelink channel is not sent or known by the base station 102.

In method 500, at Block 504, the indication of the multiple SR configurations can be transmitted to a device for transmitting SR for the logical channel. In an aspect, configuration indicating component 352, e.g., in conjunction with processor(s) 312, memory 316, transceiver 302, scheduling component 342, etc., can transmit, to the device (e.g., UE 104), the indication of the multiple SR configurations for transmitting SR for the logical channel. For example, configuration indicating component 352 can transmit the indication using an RRC message that may indicate the SR configurations and related parameters or other information, as described above. In another example, configuration indicating component 352 may identify previously-indicated or otherwise previously-configured SR configurations (e.g., by index) and/or the like. In any case, the multiple SR configurations can be determined by the device and used to transmit multiple SRs where needed (e.g., to additionally request retransmission resources when one or more data transmissions are not successfully received over the sidelink channel).

In method 500, optionally at Block 506, a first transmission of a SR can be received, from the device, based on a first one of the multiple SR configurations. In an aspect, scheduling component 342, e.g., in conjunction with processor(s) 312, memory 316, transceiver 302, etc., can receive, from the device (e.g., over PUCCH resources indicated in the SR configurations), the first transmission of the SR based on the first one of the multiple SR configurations. For example, scheduling component 342 can receive the first transmission of the SR over resources indicated in the multiple SR configurations as being for an initial SR transmission. In addition, as described, the SR can correspond to a request for sidelink channel resources (e.g., in Mode 1 V2X operations).

In method 500, optionally at Block 508, a first sidelink resource grant may be transmitted, to the device, based on the first transmission of the SR. In an aspect, configuration indicating component 352, e.g., in conjunction with processor(s) 312, memory 316, transceiver 302, scheduling component 342 etc., can transmit, to the device (e.g., UE 104) and based on the first transmission of the SR (e.g., as received from the UE 104), the first sidelink resource grant (e.g., over PDCCH, PDSCH, etc.). As described, for example, the UE 104 can use the sidelink resource grant in communicating with another UE 104, and the base station 102 may not be privy to feedback based on transmissions to the other UE 104. Thus, configuring the multiple SR configuration allows the UE 104 to again send a SR based on another SR configuration to receive another grant of sidelink resources for retransmission where NACK or no feedback is received for sidelink transmissions.

In method 500, optionally at Block 510, a second transmission of the SR can be received, from the device, based on a second one of the multiple SR configurations. In an aspect, scheduling component 342, e.g., in conjunction with processor(s) 312, memory 316, transceiver 302, etc., can receive, from the device (e.g., over PUCCH resources indicated in the SR configurations), the second transmission of the SR based on the second one of the multiple SR configurations. For example, scheduling component 342 can receive the second transmission of the SR over resources indicated in the multiple SR configurations as being for a SR for resources for retransmitting sidelink communications. In addition, as described, the SR can correspond to a request for sidelink channel resources (e.g., in Mode 1 V2X operations), and may be sent where the UE 104 received NACK or no feedback for sidelink communications transmitted over the first sidelink resource grant.

In method 500, optionally at Block 512, a second sidelink resource grant may be transmitted, to the device, based on the second transmission of the SR. In an aspect, configuration indicating component 352, e.g., in conjunction with processor(s) 312, memory 316, transceiver 302, scheduling component 342 etc., can transmit, to the device (e.g., UE 104) and based on the second transmission of the SR (e.g., as received from the UE 104), the second sidelink resource grant (e.g., over PDCCH, PDSCH, etc.). As described, for example, the UE 104 can use the second sidelink resource grant for retransmitting sidelink communications to another UE 104. In one example, the UE 104 may again send a SR to the base station 102 over additional resources in the SR configurations where NACK or no feedback is received for sidelink transmissions over the second sidelink resource grant (e.g., until all SR configurations are used). In this example, configuration indicating component 352 can continue transmitting sidelink resources grants to the UE 104 based on the different SRs to provide resources for retransmitting the sidelink communications multiple times. In these examples, the transmitting of the multiple indications of SR configurations can occur before any SRs are received, as described.

FIG. 6 is a block diagram of a MIMO communication system 600 including a base station 102 and a UE 104. The MIMO communication system 600 may illustrate aspects of the wireless communication access network 100 described with reference to FIG. 1. The base station 102 may be an example of aspects of the base station 102 described with reference to FIG. 1. The base station 102 may be equipped with antennas 634 and 635, and the UE 104 may be equipped with antennas 652 and 653. In the MIMO communication system 600, the base station 102 may be able to send data over multiple communication links at the same time. Each communication link may be called a “layer” and the “rank” of the communication link may indicate the number of layers used for communication. For example, in a 2×2 MIMO communication system where base station 102 transmits two “layers,” the rank of the communication link between the base station 102 and the UE 104 is two.

At the base station 102, a transmit (Tx) processor 620 may receive data from a data source. The transmit processor 620 may process the data. The transmit processor 620 may also generate control symbols or reference symbols. A transmit MIMO processor 630 may perform spatial processing (e.g., precoding) on data symbols, control symbols, or reference symbols, if applicable, and may provide output symbol streams to the transmit modulator/demodulators 632 and 633. Each modulator/demodulator 632 through 633 may process a respective output symbol stream (e.g., for OFDM, etc.) to obtain an output sample stream. Each modulator/demodulator 632 through 633 may further process (e.g., convert to analog, amplify, filter, and upconvert) the output sample stream to obtain a DL signal. In one example, DL signals from modulator/demodulators 632 and 633 may be transmitted via the antennas 634 and 635, respectively.

The UE 104 may be an example of aspects of the UEs 104 described with reference to FIGS. 1-2. At the UE 104, the UE antennas 652 and 653 may receive the DL signals from the base station 102 and may provide the received signals to the modulator/demodulators 654 and 655, respectively. Each modulator/demodulator 654 through 655 may condition (e.g., filter, amplify, downconvert, and digitize) a respective received signal to obtain input samples. Each modulator/demodulator 654 through 655 may further process the input samples (e.g., for OFDM, etc.) to obtain received symbols. A MIMO detector 656 may obtain received symbols from the modulator/demodulators 654 and 655, perform MIMO detection on the received symbols, if applicable, and provide detected symbols. A receive (Rx) processor 658 may process (e.g., demodulate, deinterleave, and decode) the detected symbols, providing decoded data for the UE 104 to a data output, and provide decoded control information to a processor 680, or memory 682.

The processor 680 may in some cases execute stored instructions to instantiate a communicating component 242 (see e.g., FIGS. 1 and 2).

On the uplink (UL), at the UE 104, a transmit processor 664 may receive and process data from a data source. The transmit processor 664 may also generate reference symbols for a reference signal. The symbols from the transmit processor 664 may be precoded by a transmit MIMO processor 666 if applicable, further processed by the modulator/demodulators 654 and 655 (e.g., for SC-FDMA, etc.), and be transmitted to the base station 102 in accordance with the communication parameters received from the base station 102. At the base station 102, the UL signals from the UE 104 may be received by the antennas 634 and 635, processed by the modulator/demodulators 632 and 633, detected by a MIMO detector 636 if applicable, and further processed by a receive processor 638. The receive processor 638 may provide decoded data to a data output and to the processor 640 or memory 642.

The processor 640 may in some cases execute stored instructions to instantiate a scheduling component 342 (see e.g., FIGS. 1 and 3).

The components of the UE 104 may, individually or collectively, be implemented with one or more application specific integrated circuits (ASICs) adapted to perform some or all of the applicable functions in hardware. Each of the noted modules may be a means for performing one or more functions related to operation of the MIMO communication system 600. Similarly, the components of the base station 102 may, individually or collectively, be implemented with one or more ASICs adapted to perform some or all of the applicable functions in hardware. Each of the noted components may be a means for performing one or more functions related to operation of the MIMO communication system 600.

The above detailed description set forth above in connection with the appended drawings describes examples and does not represent the only examples that may be implemented or that are within the scope of the claims. The term “example,” when used in this description, means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and apparatuses are shown in block diagram form in order to avoid obscuring the concepts of the described examples.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, computer-executable code or instructions stored on a computer-readable medium, or any combination thereof.

The various illustrative blocks and components described in connection with the disclosure herein may be implemented or performed with a specially programmed device, such as but not limited to a processor, a digital signal processor (DSP), an ASIC, a field programmable gate array (FPGA) or other programmable logic device, a discrete gate or transistor logic, a discrete hardware component, or any combination thereof designed to perform the functions described herein. A specially programmed processor may be a microprocessor, but in the alternative, the processor may be any conventional processor, controller, microcontroller, or state machine. A specially programmed processor may also be implemented as a combination of computing devices, e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a non-transitory computer-readable medium. Other examples and implementations are within the scope and spirit of the disclosure and appended claims. For example, due to the nature of software, functions described above can be implemented using software executed by a specially programmed processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the common principles defined herein may be applied to other variations without departing from the spirit or scope of the disclosure. Furthermore, although elements of the described aspects and/or embodiments may be described or claimed in the singular, the plural is contemplated unless limitation to the singular is explicitly stated. Additionally, all or a portion of any aspect and/or embodiment may be utilized with all or a portion of any other aspect and/or embodiment, unless stated otherwise. Thus, the disclosure is not to be limited to the examples and designs described herein but is to be accorded the widest scope consistent with the principles and novel features disclosed herein.

In the following, an overview of further examples is provided:

1. A method for wireless communications, comprising:
receiving an indication of multiple scheduling request (SR) configurations for a logical channel;
transmitting a first transmission of an SR based on a first one of the multiple SR configurations to request resources for transmitting data over first resources of the logical channel; and
transmitting a second transmission of the SR based on a second one of the multiple SR configurations to request resources for retransmitting the data over second resources of the logical channel.

2. The method of example 1, wherein the multiple SR configurations are received prior to transmitting the first SR and transmitting the second SR.

3. The method of any of examples 1 or 2, wherein the multiple SR configurations are configured per Bandwidth part (BWP) for the logical channel.

4. The method of any of examples 1 to 3, further comprising:
receiving, based on the first transmission of the SR, a scheduling grant for transmitting the data as sidelink communications; and
transmitting the data over the first resources indicated by the scheduling grant,
wherein transmitting the second transmission of the SR is based at least in part on at least one of receiving a negative acknowledgement (NACK) feedback for the data, or not receiving feedback for the data within a period of time.

5. The method of any of examples 1 to 4, further comprising:
receiving, based on the second transmission of the SR, a second scheduling grant for retransmitting the data as sidelink communications; and
retransmitting the data over the second resources indicated by the second scheduling grant.

6. The method of any of examples 1 to 5, wherein the indication configures at least the first resources and the second resources as uplink control channel resources for SRs for the logical channel.

7. The method of any of examples 1 to 6, wherein the indication indicates, for each SR configuration of the multiple SR configurations, whether the SR configuration is for resources for an original transmission or resources for a retransmission.

8. The method of any of examples 1 to 7, wherein an amount of the multiple SR configurations is based on a number of hybrid automatic repeat/request (HARQ) retransmissions configured for the logical channel.

9. The method of any of examples 1 to 8, wherein the logical channel is a sidelink channel with a device in vehicle-to-anything (V2X) communications.

10. The method of any of examples 1 to 9, wherein the indication is received from a base station.

11. A method for wireless communications, comprising:
generating an indication of multiple scheduling request (SR) configurations for a logical channel; and
transmitting, to a device, the indication of the multiple SR configurations for transmitting SR for the logical channel.

12. The method of example 11, wherein the indication configures multiple uplink control channel resources for SRs per Bandwidth part (BWP) for the logical channel.

13. The method of any of examples 11 or 12, wherein the indication configures multiple uplink control channel resources for SRs for the logical channel prior to receiving SR transmission.

14. The method of any of examples 11 to 13, wherein the indication indicates, for each SR configuration of the multiple SR configurations, whether the SR configuration is for resources for an original transmission or resources for a retransmission.

15. The method of any of examples 11 to 14, wherein an amount of the multiple SR configurations is based on a number of hybrid automatic repeat/request (HARQ) retransmissions configured for the logical channel.

16. The method of any of examples 11 to 15, further comprising:
receiving, from the device, a first transmission of a SR based on a first one of the multiple SR configurations; and
transmitting, to the device and based on the first transmission of the SR, a first sidelink resource grant for transmitting data over the logical channel.

17. The method of example 16, further comprising:
receiving, from the device, a second transmission of a SR based on a second one of the multiple SR configurations; and
transmitting, to the device and based on the second transmission of the SR, a second sidelink resource grant for retransmitting the data over the logical channel.

18. The method of any of examples 11 to 17, wherein the logical channel is a sidelink channel with the device in vehicle-to-anything (V2X) communications.

19. An apparatus for wireless communication, comprising:
a transceiver;
a memory configured to store instructions; and
one or more processors communicatively coupled with the transceiver and the memory, wherein the one or more processors are configured to:
   receive an indication of multiple scheduling request (SR) configurations for a logical channel;
   transmit a first transmission of an SR based on a first one of the multiple SR configurations to request resources for transmitting data over first resources of the logical channel; and
   transmit a second transmission of the SR based on a second one of the multiple SR configurations to request resources for retransmitting the data over second resources of the logical channel.

20. The apparatus of example 19, wherein the multiple SR configurations are received prior to transmitting the first SR and transmitting the second SR.

21. The apparatus of any of examples 19 or 20, wherein the multiple SR configurations are configured per Bandwidth part (BWP) for the logical channel.

22. The apparatus of any of examples 19 to 21, wherein the one or more processors are further configured to:
receive, based on the first transmission of the SR, a scheduling grant for transmitting the data as sidelink communications; and
transmit the data over the first resources indicated by the scheduling grant,
wherein the one or more processors are configured to transmit the second transmission of the SR based at least in part on at least one of receiving a negative acknowledgement (NACK) feedback for the data, or not receiving feedback for the data within a period of time.

23. The apparatus of any of examples 19 to 22, wherein the one or more processors are further configured to:
receive, based on the second transmission of the SR, a second scheduling grant for retransmitting the data as sidelink communications; and
retransmit the data over the second resources indicated by the second scheduling grant.

24. The apparatus of any of examples 19 to 23, wherein the indication configures at least the first resources and the second resources as multiple uplink control channel resources for SRs for the logical channel.

25. The apparatus of any of examples 19 to 24, wherein the indication indicates, for each SR configuration of the multiple SR configurations, whether the SR configuration is for resources for an original transmission or resources for a retransmission.

26. The apparatus of any of examples 19 to 25, wherein an amount of the multiple SR configurations is based on a number of hybrid automatic repeat/request (HARQ) retransmissions configured for the logical channel.

27. The apparatus of any of examples 19 to 26, wherein the logical channel is a sidelink channel with a device in vehicle-to-anything (V2X) communications.

28. The apparatus of any of examples 19 to 27, wherein the indication is received from a base station.

29. An apparatus for wireless communication, comprising:
a transceiver;
a memory configured to store instructions; and
one or more processors communicatively coupled with the transceiver and the memory, wherein the one or more processors are configured to:
   generate an indication of multiple scheduling request (SR) configurations for a logical channel; and
   transmit, to a device, the indication of the multiple SR configurations for transmitting SR for the logical channel.

30. The apparatus of example 29, wherein the indication configures multiple uplink control channel resources for SRs per Bandwidth part (BWP) for the logical channel.

What is claimed is:

1. A method for wireless communications, comprising:
receiving an indication of multiple scheduling request (SR) configurations for a logical channel;
transmitting a first transmission of an SR based on a first one of the multiple SR configurations to request resources for transmitting data over first resources of the logical channel; and
transmitting a second transmission of the SR based on a second one of the multiple SR configurations to request resources for retransmitting the data over second resources of the logical channel.

2. The method of claim 1, wherein the multiple SR configurations are received prior to transmitting the first SR and transmitting the second SR.

3. The method of claim 1, wherein the multiple SR configurations are configured per Bandwidth part (BWP) for the logical channel.

4. The method of claim 1, further comprising:
receiving, based on the first transmission of the SR, a scheduling grant for transmitting the data as sidelink communications; and
transmitting the data over the first resources indicated by the scheduling grant,
wherein transmitting the second transmission of the SR is based at least in part on at least one of receiving a negative acknowledgement (NACK) feedback for the data, or not receiving feedback for the data within a period of time.

5. The method of claim 1, further comprising:
receiving, based on the second transmission of the SR, a second scheduling grant for retransmitting the data as sidelink communications; and
retransmitting the data over the second resources indicated by the second scheduling grant.

6. The method of claim 1, wherein the indication configures at least the first resources and the second resources as uplink control channel resources for SRs for the logical channel.

7. The method of claim 1, wherein the indication indicates, for each SR configuration of the multiple SR configurations, whether the SR configuration is for resources for an original transmission or resources for a retransmission.

8. The method of claim 1, wherein an amount of the multiple SR configurations is based on a number of hybrid automatic repeat/request (HARQ) retransmissions configured for the logical channel.

9. The method of claim 1, wherein the logical channel is a sidelink channel with a device in vehicle-to-anything (V2X) communications.

10. The method of claim 1, wherein the indication is received from a base station.

11. A method for wireless communications, comprising:
generating an indication of multiple scheduling request (SR) configurations for a logical channel; and
transmitting, to a device, the indication of the multiple SR configurations for transmitting SR for the logical channel.

12. The method of claim 11, wherein the indication configures multiple uplink control channel resources for SRs per Bandwidth part (BWP) for the logical channel.

13. The method of claim 11, wherein the indication configures multiple uplink control channel resources for SRs for the logical channel prior to receiving SR transmission.

14. The method of claim 11, wherein the indication indicates, for each SR configuration of the multiple SR configurations, whether the SR configuration is for resources for an original transmission or resources for a retransmission.

15. The method of claim 11, wherein an amount of the multiple SR configurations is based on a number of hybrid automatic repeat/request (HARQ) retransmissions configured for the logical channel.

16. The method of claim 11, further comprising:
receiving, from the device, a first transmission of a SR based on a first one of the multiple SR configurations; and
transmitting, to the device and based on the first transmission of the SR, a first sidelink resource grant for transmitting data over the logical channel.

17. The method of claim 16, further comprising:
receiving, from the device, a second transmission of a SR based on a second one of the multiple SR configurations; and
transmitting, to the device and based on the second transmission of the SR, a second sidelink resource grant for retransmitting the data over the logical channel.

18. The method of claim 11, wherein the logical channel is a sidelink channel with the device in vehicle-to-anything (V2X) communications.

19. An apparatus for wireless communication, comprising:
a transceiver;
a memory configured to store instructions; and
one or more processors communicatively coupled with the transceiver and the memory, wherein the one or more processors are configured to:
receive an indication of multiple scheduling request (SR) configurations for a logical channel;
transmit a first transmission of an SR based on a first one of the multiple SR configurations to request resources for transmitting data over first resources of the logical channel; and
transmit a second transmission of the SR based on a second one of the multiple SR configurations to request resources for retransmitting the data over second resources of the logical channel.

20. The apparatus of claim 19, wherein the multiple SR configurations are received prior to transmitting the first SR and transmitting the second SR.

21. The apparatus of claim 19, wherein the multiple SR configurations are configured per Bandwidth part (BWP) for the logical channel.

22. The apparatus of claim 19, wherein the one or more processors are further configured to:
receive, based on the first transmission of the SR, a scheduling grant for transmitting the data as sidelink communications; and
transmit the data over the first resources indicated by the scheduling grant,
wherein the one or more processors are configured to transmit the second transmission of the SR based at least in part on at least one of receiving a negative acknowledgement (NACK) feedback for the data, or not receiving feedback for the data within a period of time.

23. The apparatus of claim 19, wherein the one or more processors are further configured to:
receive, based on the second transmission of the SR, a second scheduling grant for retransmitting the data as sidelink communications; and
retransmit the data over the second resources indicated by the second scheduling grant.

24. The apparatus of claim 19, wherein the indication configures at least the first resources and the second resources as multiple uplink control channel resources for SRs for the logical channel.

25. The apparatus of claim 19, wherein the indication indicates, for each SR configuration of the multiple SR configurations, whether the SR configuration is for resources for an original transmission or resources for a retransmission.

26. The apparatus of claim 19, wherein an amount of the multiple SR configurations is based on a number of hybrid automatic repeat/request (HARQ) retransmissions configured for the logical channel.

27. The apparatus of claim 19, wherein the logical channel is a sidelink channel with a device in vehicle-to-anything (V2X) communications.

28. The apparatus of claim 19, wherein the indication is received from a base station.

29. An apparatus for wireless communication, comprising:
a transceiver;
a memory configured to store instructions; and
one or more processors communicatively coupled with the transceiver and the memory, wherein the one or more processors are configured to:
generate an indication of multiple scheduling request (SR) configurations for a logical channel; and
transmit, to a device, the indication of the multiple SR configurations for transmitting SR for the logical channel.

30. The apparatus of claim 29, wherein the indication configures multiple uplink control channel resources for SRs per Bandwidth part (BWP) for the logical channel.
